(19) United States
(12) Patent Application Publication
(10) Pub. No.: US 2004/0163115 A1
(43) Pub. Date: Aug. 19, 2004

(54) Broadcasting of live events with inserted interruptions

(76) Inventor: Dane C. Butzer, Columbus, OH (US)

Correspondence Address: Dane C. Butzer, 681 Woodduck Ct., Columbus, OH, 43215, US

(21) Appl. No.: 10/368,653

(22) Filed: Feb. 18, 2003

(51) Int. Cl. H04N 7/173

(52) U.S. Cl. 725/88; 725/87; 725/92; 725/93; 725/94

(57) ABSTRACT

A technique that seamlessly broadcasts a live event from a point that occurs before or during an interruption through a point that occurs after the interruption. This seamless broadcast is accomplished by storing data for the live event during and preferably after the interruption and broadcasting at least part of the stored data until the broadcast of the live event catches up to the live event. Techniques for catching up to the live event include, but are not limited to, editing of the stored data and time-compressed broadcasting of the data.

### BACKGROUND OF THE INVENTION

1. Field of the Invention

This invention relates to broadcasting live events with inserted interruptions, for example commercials. In particular, the invention concerns returning to a broadcast from an interruption at a point that occurred before or during the interruption.

2. Description of the Related Art

Live broadcast of an event adds to the excitement and interest of viewers of the event broadcast. For example, a sporting event, news event, or the like is much more enthralling when broadcast live; the uncertainty of the actual outcome of the event holds each viewer's attention.

One problem with broadcasting live events is that parts of the event can be missed when the broadcast breaks for an interruption. Examples of such interruptions include, but are not limited to, commercials, news update, and the like.

Two primary approaches have been used to address this problem. First, instant replay can be used after the interruption is over to broadcast missed parts of the event. Second, the event itself can be interrupted during the interruption in the broadcast. Both of these approaches have drawbacks.

Instant replay causes a broadcast of an event to jump back and forth in time. This jumping can impart a disjointed feeling to the broadcast. Overuse of instant replay exacerbates this feeling, which in turn can reduce a viewer's sense that he or she is seeing the event as it actually unfolds. As a result, the viewer might become less enthralled with the event, perhaps even to the extent that the viewer stops viewing the broadcast. If enough viewers stop viewing the broadcast, ratings for the broadcast can fall, thereby impacting the value of the broadcast (e.g., price that can be charged for commercials, pay-per-view, etc.).

Interrupting the event itself permits a viewer to see the event without the disjointed feeling caused by instant replay. However, actual spectators present at the event can become annoyed by interruption of the event. The interruption also can actually disrupt the event. Furthermore, some events are not susceptible to interruption.

One common broadcast that utilizes both of the foregoing techniques is broadcast of an (American) football game. Such a broadcast is often interrupted for commercials, updates on other games and events, news breaks, station identification breaks, and the like.

Instant replay can be used to broadcast parts (e.g., plays) of the football game that occur during such interruptions. However, when a viewer sees a play for the first time as an instant replay, the viewer is acutely aware that what they are seeing has already occurred. This can lessen the viewer's interest in the football game, which in turn can hurt ratings for the broadcast of the game.

Use of “television timeouts” has become prevalent in an attempt to avoid problems caused by use and overuse of instant replay to compensate for interruptions. However, television timeouts are almost universally reviled by fans actually present at football games. In addition, idle time during television timeouts can interrupt the flow and momentum of a game. Because of these factors, television timeouts provide a far less than ideal technique for handling interruptions.

As noted above, some events simply are not susceptible to interruptions such as television timeouts. For example, soccer games do not have timeouts, let alone television timeouts. Likewise, certain live artistic performances, news events, and the like similarly are not easily interrupted.

### SUMMARY OF THE INVENTION

The invention addresses the foregoing issues through a technique that seamlessly broadcasts a live event from a point that occurs before or during an interruption through a point that occurs after the interruption. This seamless broadcast is accomplished by storing data for the live event during and preferably after the interruption and broadcasting at least part of the stored data until the broadcast of the live event catches up to the live event. Techniques for catching up to the live event include, but are not limited to, editing of the stored data and time-compression of the data.

Thus, one aspect of the invention is a method that includes the steps of broadcasting a live event, breaking from the live event for an interruption, returning to the live event at a first point that occurred before or during the interruption, and seamlessly broadcasting from the first point through a second point that occurs after the interruption.

Preferably, the method also includes the step of storing data for the live event during or during and after the interruption, and the step of seamlessly broadcasting from the first point through the second point includes broadcasting at least part of the stored data. The broadcasting of at least part of the stored data preferably continues until the broadcast of the live event catches up to the live event. Of course, data for the live event also can be stored before the interruption and possibly broadcast at least in part.

In a preferred embodiment, broadcasting at least part of the stored data can take less time than a corresponding part of the live event. For example, broadcasting at least part of the stored data can use time compression such that the stored data is broadcast at a faster rate than the live event, editing such that less than all of the stored data is broadcast, or both. Other techniques can be used.

The invention preferably provides an operator with an indication of an amount of stored data, an amount of additional data that can be stored, or both an amount of stored data and an amount of additional data that can be stored. This indication can help the operator to coordinate more effectively storage and broadcasting of data for the live event.

The invention is applicable to various different types of live events and interruptions. In one context, the event is a football game and the interruptions are commercials. In this context, the steps of returning to the live event at the first point and seamlessly broadcasting from the first point through the second point permits broadcasting of the football game to seamlessly include play that occurred during and after the interruption. As a result, commercials can be inserted into the broadcast of the football game without use of television timeouts or instant replays.

Another aspect of the invention is an apparatus that implements the foregoing methods. In a preferred embodiment, this apparatus uses a buffer arranged in a first-in-first-out fashion to store data for the live event. Alternatively, random access or any other type of memory or storage media can be used.

The invention can be embodied in specialized hardware, for example mixing and control boards for producing, broadcasting, or retransmitting an event. The invention also can be embodied in general purpose or otherwise programmable computers with sufficient processing power, input/output capacity and memory to implement the invention.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWINGS

FIG. 1 illustrates seamless handling of interruptions to a broadcast of a live event according to one embodiment of the invention.

FIG. 2 is a flowchart of a method for seamlessly handling interruptions to a broadcast of a live event according to one embodiment of the invention.

FIG. 3 is a block diagram of control and mixing boards that can be used to implement one embodiment of the invention at a source of a live broadcast.

FIG. 4 is a block diagram of control and mixing boards that can be used to implement one embodiment of the invention at a transmitter or retransmitter of a live broadcast.

FIG. 5 is a block diagram of a computer that can be used to implement one embodiment of the invention.

### DESCRIPTION OF THE PREFERRED EMBODIMENT

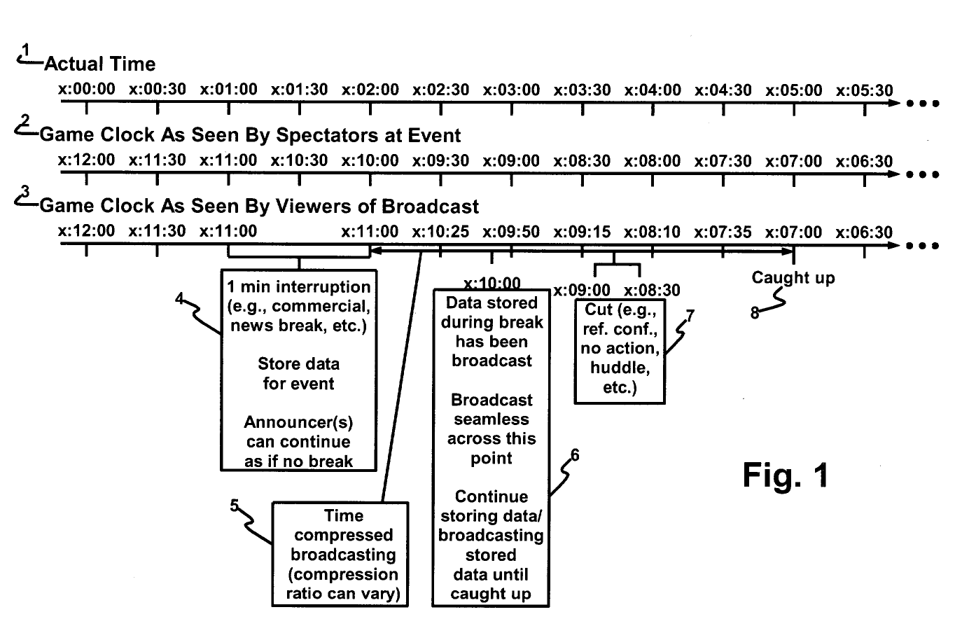

FIG. 1 illustrates seamless handling of interruptions to a broadcast of a live event according to one embodiment of the invention. The invention is not limited to the times and events shown in FIG. 1. Rather, FIG. 1 illustrates a particular example of the general principles of the invention.

In FIG. 1, actual timeline 1 is a timeline for a live event. A total of five minutes thirty seconds is shown. Of course, the invention is not limited to this time period or timeline.

The live event could be a sporting event, live performance, news event or some other event. Throughout this application, the example of a football game is often used. The applicability of the invention to other live events would not require any additional invention or undue experimentation.

Game clock timeline 2 is a timeline showing a game clock as seen by spectators at the live event. Game clock timeline 3 is a timeline showing the same game clock as seen by viewers of the broadcast of the live event. Game clock timelines 2 and 3 show a relationship between a broadcast of the live event and the passage of time at the live event.

Substantially unavoidable delays such as transmission delays are always present in a broadcast. The presence of such delays is assumed. However, for the sake of simplicity, such delays are not shown. Thus, for example, when game clock timelines 2 and 3 are shown and described as coinciding, a small delay is still present due to such unavoidable delays.

At actual time x:00:00 in FIG. 1, the game clock as seen by both spectators and viewers coincides at x:12:00. At game clock time x:11:00 (actual time x:01:00), the broadcast breaks for interruption 4. The interruption in FIG. 1 is a one minute commercial, news break, or the like. The invention is equally applicable to other types and durations of interruptions.

In prior art broadcasting techniques, the live event itself would often be interrupted so that no live action would be missed when broadcasting resumed. An example of this type of interruption to the live event is a so-called television timeout for a football game.

The disadvantage of such timeouts is that they are almost universally reviled by spectators actually present at the live event. In addition, idle time during television timeouts can interrupt the flow and momentum of the live event. Furthermore, some events simply are not susceptible to interruptions such as television timeouts.

While timeouts can be used in conjunction with the invention to accommodate interruptions, the invention provides an alternative. In this alternative, the event itself is not interrupted or is interrupted for a shorter period of time than the break in the broadcast. Announcers at the live event can continue to announce as if no interruption had occurred. Alternatively, they could note that after the interruption, the broadcast will resume at or near the same point the broadcast left the live event.

During the interruption, data for the live event is stored. After the interruption, some or all of the stored data is broadcast. Thus, in FIG. 1, game clock timeline 3 shows the game clock at x:11:00 both before and after interruption 4. There is no requirement that the broadcast pick up at exactly the same point as the broadcast left the interruption; however, the invention can be implemented so as to provide this capability.

At actual time x:02:00, the game clock as seen by spectators at the live event shows x:10:00, while the game clock as seen be viewers of the broadcast of the live event shows x:11:00. The live event and the broadcast are offset by the duration of the interruption, which in FIG. 1 is one minute.

During the entire duration of a live event, the total of all interruptions could be significant. Therefore, if the broadcast was simply delayed for each interruption, the broadcast could become significantly offset from the broadcast. In some cases, this would be perfectly acceptable. However, the invention provides an alternative to this situation.

In particular, the broadcast of the stored data can be time compressed. For example, one minute and some small number of seconds of stored data could be broadcast in each minute of actual time. This is shown by time compressed broadcasting 5 in FIG. 1, and by game clock time line 3 slowly catching up to game clock time line 2.

The degree of time compression can vary. For example, during huddles and referee conferences, between plays, and at other less important times, the compression can be increased, even to a noticeable level. During more important parts, less or even no compression could be used.

As long as the broadcast is offset from the actual live event, data for the broadcast is stored so that it can be broadcast in sequence. Thus, at about time 6, which corresponds to actual time x:02:50, game clock timeline 2 time x:09:10, and game clock timeline 3 time x:10:00, all data stored during interruption 4 has been broadcast. Data for the live event continues to be stored and later broadcast until the broadcast catches up to the live event.

Broadcasting across time 6 preferably is seamless. The term “seamless” indicates that no discernable jump is used to transition from broadcasting data stored during the interruption to broadcasting data stored after the interruption. As a result, viewers of the broadcast preferably will largely be unaware of the transition and also unaware that they are seeing a slightly delayed broadcast, unless an announcer or the like makes them explicitly aware of these facts.

The seamless nature of the transition is different from what occurs with prior art instant replays. With instant replays, the broadcast jumps from the end of the replay back to the live broadcast. This jump imparts a disjointed feel to the broadcast. Instant replays still have their uses. However, overuse of replays to account for all interruptions would create such a disjointed broadcast that it would be extremely distracting. The seamless transition of the invention largely avoids this problem.

The viewers can be made aware of the transition and delay by the announcers, broadcasters, advertisers, or the like without departing from the invention. For example, before an interruption, an announcer could state something along the lines of the following: “We are breaking from a commercial, but play will pick up exactly right here after the break.” Similarly, some visual or audio cue could be added in order to showcase the invention. Alternatively, the invention could be implemented unobtrusively without any such cues or announcements.

Besides time compressed broadcasting 5, other techniques can be used to catch the broadcast up to the live event. One of these techniques is to cut unimportant parts from the broadcast of the live event. Unimportant parts can include, but are not limited to, referee conferences, huddles, regular timeouts, time between plays or actions in the live event, and the like. In FIG. 1, cut 7 catches the broadcast up by thirty seconds.

At about time 8, which corresponds to actual time x:05:00, game clock timeline 2 time x:07:00, and game clock timeline 3 time x:07:00, the broadcast has caught up to the live event (except, of course, for unavoidable delays such as transmission delays). Before or after time 8, other interruptions to the broadcast could have occurred, in which case data for the live event would be stored and later broadcast, and the broadcast preferably would attempt to catch up to the live event using techniques such as those described above.

In the context of a football game, the time lines shown in FIG. 1 illustrate how the invention permits broadcasting of the football game to seamlessly include play that occurred during and after interruptions. As a result, at least some commercials can be inserted into such broadcasts without overuse of television timeouts or instant replays.

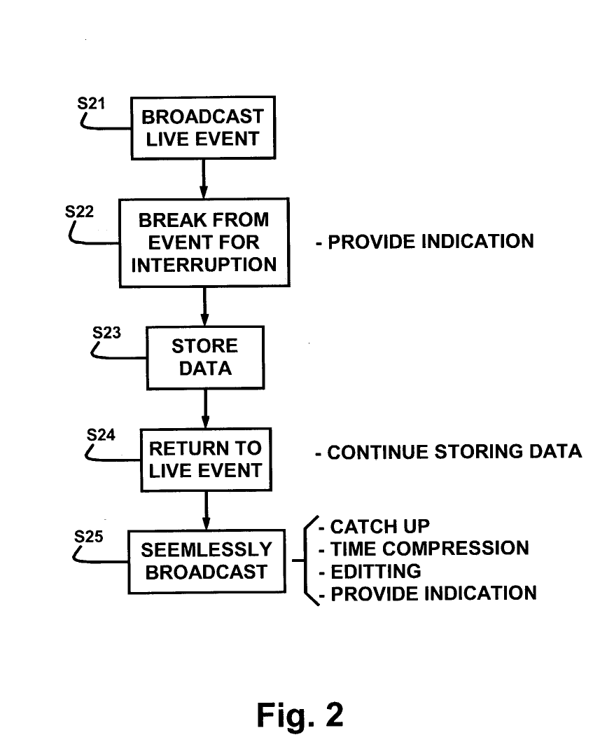

FIG. 2 is a flowchart of a method for seamlessly handling interruptions to a broadcast of a live event according to one embodiment of the invention.

In step S21, broadcast of a live event begins.

At step S22, the broadcast is interrupted for a break such as a commercial, news break, or the like. Before the interruption, an indication of the pending interruption preferably is provided to announcers, operators, or the like.

Data for the live event during the interruption is stored in step S23. Then, in step S24, the broadcast returns to the live event at a first point that occurred before or during the interruption. The broadcast returns to this point by broadcasting data that was stored during the interruption. Data for the live event itself preferably continues to be stored.

At step S25, broadcasting of the stored data continues. The broadcast continues seamlessly from the first point through a second point that occurs after the interruption. The term “seamless” indicates that no discernable jump is used to transition from broadcasting data stored during the interruption to broadcasting data stored after the interruption. As a result, viewers of the broadcast preferably will largely be unaware of the transition and also unaware that they are seeing a slightly delayed broadcast, unless an announcer or the like makes them explicitly aware of these facts.

At least part of the stored data is broadcast until the broadcast of the live event catches up to the live event. In a preferred embodiment, broadcasting at least part of the stored data can take less time than a corresponding part of the live event. For example, broadcasting at least part of the stored data can use time compression such that the stored data is broadcast at a faster rate than the live event, editing such that less than all of the stored data is broadcast, or both. Other techniques can be used.

The invention preferably provides an operator with an indication of an amount of stored data, an amount of additional data that can be stored, or both an amount of stored data and an amount of additional data that can be stored. This indication can help the operator to coordinate more effectively storage and broadcasting of data for the live event.

Flow can branch back to step S22 at any point in the method. In other words, the broadcast does not have to be caught up before another interruption can be handled. In such a case, the delays caused by the interruptions preferably aggregate, and data preferably continues to be stored until the broadcast catches up to the live event.

In an alternative embodiment, data for the live event can be stored even before the interruption. In this variation, a portion of the data stored before the interruption can be re-broadcast in order to provide context for subsequent activity in the event. For example, if a break occurs in the middle of a play in a football game, the broadcast could use data stored before the interruption to pick up the broadcast at the start of the play.

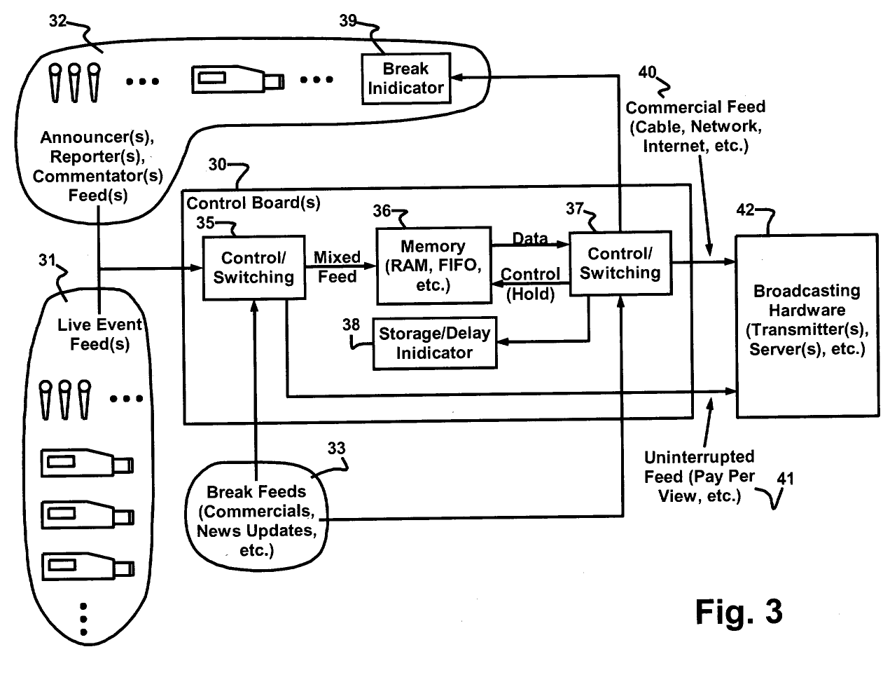

FIG. 3 is a block diagram of control and mixing boards that can be used to implement one embodiment of the invention at a source of a live broadcast.

Control and mixing board(s) 30 include at least one input interface for feeds from various sources. These feeds preferably include live event feeds 31, which are feeds from one or more cameras, microphones, and the like trained on a live event. The feeds also can include announcers', reporters', and commentator' feeds 32. In addition, the feeds preferably include break feeds 33 for interruptions such as commercials, news updates, and the like. The feeds preferably carry audio, video, and/or other types of data in analog, digital, or some other format. Some of the feeds can come from pre-recorded sources, while others can be live.

Some or all of the various feeds preferably are combined at control/switching station 35. Operators at this control/switching station can select and combine data from the various feeds into a mixed feed.

Preferably, the mixed feed only includes data from live event feeds 31 and announcers', reporters', and commentators' feeds 32. Alternatively, the mixed feed could include just data from live event feeds 31, or the mixed feed could include data from all of the feeds including break feeds 33. The included data from break feeds 33 preferably is limited to interruptions that the invention is not used to handle. Possible examples of such interruptions include, but are not limited to, half time reports, commercials that occur during breaks in the live event (e.g., regular time outs), short commercials or commercials that occur during less important or interesting part of the event, and the like.

Data from the mix feed is input to memory 36. Preferably, the memory has two modes. In the first mode, data passes through or bypasses the memory. This mode can be used when no data needs to be stored (i.e., when the broadcast of the live event coincides with the live event).

In the second mode, the memory preferably operates in a first-in-first-out (FIFO) fashion. The memory should be fast enough to store and to read out data for broadcast in real time. In addition, the memory should have enough capacity to store a significant amount, preferably several minutes, of data from the mixed feed.

Many different types of memories can serve as memory 36. Examples include, but are not limited to, FIFO buffers, random access memory, hard disk drives, optical storage, and other types of mass storage.

Operators at control/switching station 37 preferably can control the mode of memory 36. Data from memory 36 preferably passes through the station for review, for example on a computer screen or monitor. Furthermore, in a preferred embodiment, the operators can directly edit data in memory 36 from control/switching station 37, for example to remove portions of the data.

Control/switching station 37 also permits the operators to control transmission of data to an output interface. The station preferably controls sending data from memory 36 and break feeds 33 so as to implement the techniques described above with respect to FIGS. 1 and 2.

Preferably, storage/delay indicator 38 provides the operators with an indication of an amount of data stored in memory 36, an amount of additional data that can be stored in memory 36, or both. This indication preferably can be in terms of a number of bytes, an amount of time corresponding to the stored data, or some other form. The indicator can help the operators coordinate more effectively storage and broadcasting of data for the live event and for the interruptions.

Break indicator 39 can be included to provide announcers, reporters, or commentators with an indication that a break is about to begin or end. This indication would permit the announcers, reporters, or commentators to make announcements highlighting the invention. Alternatively, the invention can operate transparently to the announcers, reporters, and commentators, in which case break indicator 39 would be extraneous.

The various control/switching stations and indicators can be combined in various ways. For example, control/switching stations 35 and 37 can be combined into a single station. In a preferred embodiment, the stations and indications are implemented through graphical user interfaces on one or more computer control consoles.

Control board(s) 30 preferably can generate different outputs. For example, one output could include commercials and other breaks inserted using techniques discussed in this application. Such an output is shown in FIG. 3 as commercial feed 40, which can be a cable feed, a network feed, an internet feed, or some other type of feed.

Another output could be an uninterrupted feed. Such an output is shown as uninterrupted feed 41. The uninterrupted feed could be broadcast on premium or pay-per-view channels, provided for broadcast through subscription websites, fed to a central location for a network or to some other site for further processing, or used in some other fashion.

One or both of the feeds are connected to broadcasting hardware 42 which broadcasts the data from the feed(s). This hardware could take the form of a traditional transmitter, a cable head end, or a server for online broadcasting. Any other types of broadcasting hardware can be used with the invention.

The arrangement shown in FIG. 3 preferably is situated at the location of the live event. However, the invention is not limited to such locations; the invention can be applied at locations that are remote from the live event. Examples of such locations include, but are not limited to, the locations of any transmitters or retransmitters for the broadcast.

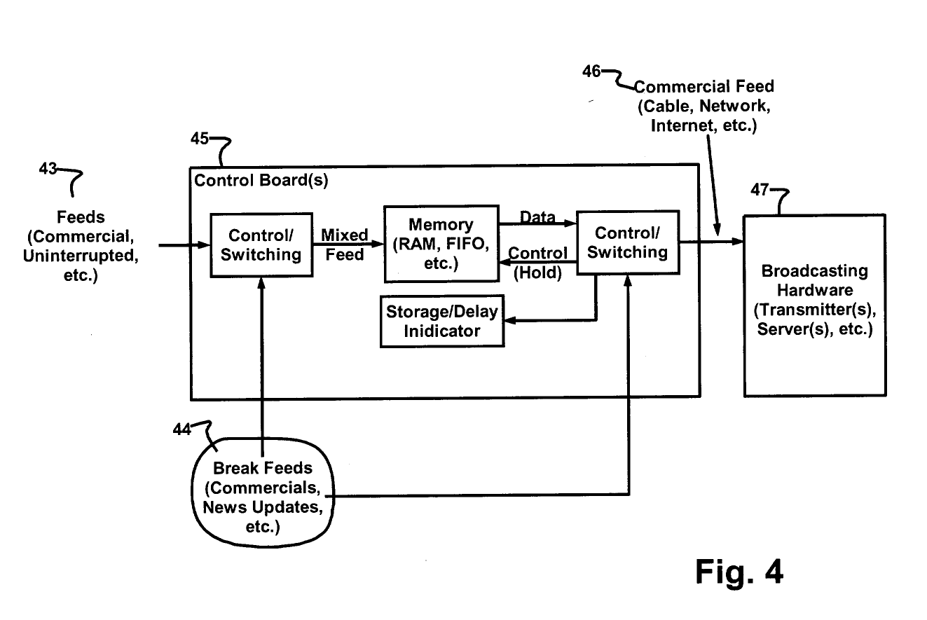

FIG. 4 is a block diagram of control and mixing boards that can be used to implement one embodiment of the invention at a transmitter or retransmitter of a live broadcast.

Feed 43 includes one or more feeds for an event to be broadcast. Break feeds 44 include one or more feeds for interruptions such as commercials, news updates, and the like. Control and mixing board(s) 45 can be used to insert the interruptions from break feeds 44 into data from feed 43 for the event.

Feed 43 can be drawn from commercial feed 40 or uninterrupted feed 41 shown in FIG. 4. Feed 43 also can be drawn from some other source, for example another broadcast.

Control board(s) 45 preferably include control/switching stations, memory, and a storage/delay indicator. The control board(s) preferably implement the techniques described above with respect to FIGS. 1 and 2.

The output of control board(s) 45 in FIG. 4 is commercial feed 46, which can be a cable feed, a network feed, an internet feed, or some other type of feed. Broadcasting hardware 47 broadcasts data from commercial feed 46.

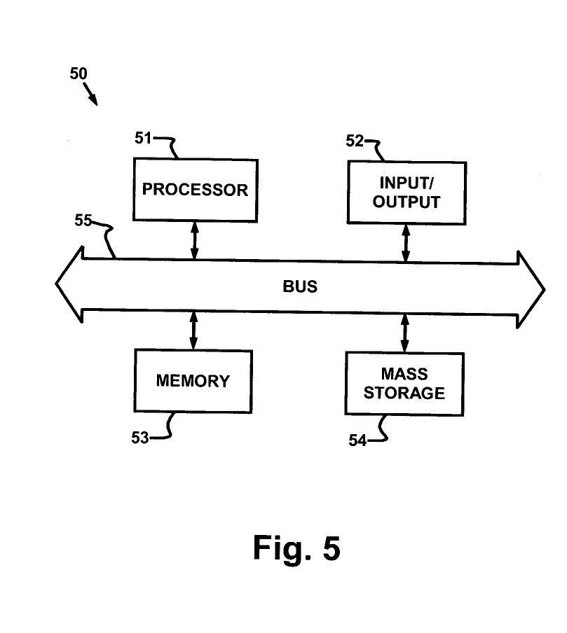

FIG. 5 is a block diagram of a computer that can be used to implement one embodiment of the invention.

In the descriptions of FIGS. 1 to 4, preferred embodiments of the invention are described with regard to preferred process steps and hardware. However, those skilled in the art would recognize, after perusal of this application, that embodiments of the invention may be implemented using one or more general purpose processors or special purpose processors adapted to particular process steps and data structures operating under program control, that such process steps and data structures can be embodied as information stored in or transmitted to and from memories (e.g., fixed memories such as DRAMs, SRAMs, hard disks, caches, etc., and removable memories such as floppy disks, CD-ROMs, data tapes, etc.) including instructions executable by such processors (e.g., object code that is directly executable, source code that is executable after compilation, code that is executable through interpretation, etc.), and that implementation of the preferred process steps and data structures described herein using such equipment would not require undue experimentation or further invention.

In this regard, FIG. 5 shows computer hardware 50 including general or special purpose processor 51, input/output interface 52, memory 53, and mass storage 54, all interconnected via bus 55 so as to implement the techniques discussed above. The invention can be implemented using types and arrangements of hardware different from those shown in FIG. 5.

Alternative Embodiments

The methods of the invention can be implemented using apparatuses different from those discussed in this application. Likewise, the apparatuses of the invention can implement methods different from those discussed in this application. Furthermore, although preferred embodiments of the invention are disclosed herein, many variations are possible which remain within the content, scope and spirit of the invention, and these variations would become clear to those skilled in the art after perusal of this application.

What is claimed is:

1. A method comprising the steps of:
broadcasting a live event;
breaking from the live event for an interruption;
returning to the live event at a first point that occurred before or during the interruption; and
seamlessly broadcasting from the first point through a second point that occurs after the interruption.

2. A method as in claim 1, wherein the live event is broadcast for television.

3. A method as in claim 1, wherein the live event is broadcast for radio.

4. A method as in claim 1, further comprising the step of storing data for the live event during the interruption or during and after the interruption, wherein the step of seamlessly broadcasting from the first point through the second point further comprises broadcasting at least part of the stored data.

5. A method as in claim 4, wherein broadcasting at least part of the stored data continues until the broadcast of the live event catches up to the live event.

6. A method as in claim 5, wherein broadcasting at least part of the stored data takes less time than a corresponding part of the live event.

7. A method as in claim 6, wherein broadcasting at least part of the stored data uses time compression such that the stored data is broadcast at a faster rate than the live event.

8. A method as in claim 6, wherein broadcasting at least part of the stored data uses editing such that less than all of the stored data is broadcast.

9. A method as in claim 4, wherein the step of storing data for the live event further comprises storing data for the live event before the interruption.

10. A method as in claim 4, further comprising the step of providing an operator with an indication of an amount of stored data, an amount of additional data that can be stored, or both an amount of stored data and an amount of additional data that can be stored.

11. A method as in claim 1, wherein the live event is a sporting event, live performance, or news event.

12. A method as in claim 11, wherein the sporting event is a football game, the interruption is a commercial break, and the steps of returning to the live event at the first point and seamlessly broadcasting from the first point through the second point permit broadcasting of the football game to seamlessly include play that occurred during and after the interruption, thereby permitting commercials to be inserted into broadcasting the football game without use of television timeouts or instant replays.

13. An apparatus comprising:
at least one input interface for one or more input feeds from a live event and from one or more interruptions;
at least one output interface to broadcast hardware;
a memory that can store data from a mixed feed;
one or more control and switching mechanisms that can combine data from the input feeds into the mixed feed, control storing of the data from the mixed feed into the memory, and control sending of the data from the mixed feed and the memory to the output interface;
wherein the control and switching mechanisms control sending the data to the output interface to permit broadcasting the live event, breaking from the live event for an interruption, returning to the live event at a first point that occurred before or during the interruption, and sending the data to the output interface to permit seamless broadcasting from the first point through a second point that occurs after the interruption.

14. An apparatus as in claim 13, wherein the input feeds further include feeds from one or more announcers, reporters, or commentators.

15. An apparatus as in claim 13, wherein the control and switching mechanisms further control storing the data for the live event during the interruption or during and after the interruption, and wherein sending the data to the output interface further comprises sending at least part of the stored data.

16. An apparatus as in claim 15, wherein sending at least part of the stored data continues until the broadcast of the live event catches up to the live event.

17. An apparatus as in claim 16, wherein broadcasting at least part of the stored data takes less time than a corresponding part of the live event.

18. An apparatus as in claim 17, wherein broadcasting at least part of the stored data uses time compression such that the stored data is broadcast at a faster rate than the live event.

19. An apparatus as in claim 17, wherein broadcasting at least part of the stored data uses editing such that less than all of the stored data is broadcast.

20. An apparatus as in claim 15, wherein the control and switching mechanisms further control storing the data for the live event before the interruption.

21. An apparatus as in claim 15, further comprising an indicator of an amount of stored data, an amount of additional data that can be stored, or both an amount of stored data and an amount of additional data that can be stored.

22. An apparatus as in claim 13, wherein the live event is a football game, the interruption is a commercial break, and the apparatus permits broadcasting of the football game to seamlessly include play that occurred during and after the interruption, thereby permitting commercials to be inserted into broadcasting the football game without use of television timeouts or instant replays.

23. A memory storing information including instructions executable by a processor to control broadcasting a live event with interruptions, the instructions including the steps of: broadcasting the live event, breaking from the live event for an interruption, returning to the live event at a first point that occurred before or during the interruption, and seamlessly broadcasting from the first point through a second point that occurs after the interruption.

24. A memory as in claim 23, wherein the instructions further comprise the step of storing data for the live event during the interruption or during and after the interruption, and wherein the step of seamlessly broadcasting from the first point through the second point further comprises broadcasting at least part of the stored data.

25. A memory as in claim 24, wherein broadcasting at least part of the stored data continues until the broadcast of the live event catches up to the live event.

26. A memory as in claim 25, wherein broadcasting at least part of the stored data takes less time than a corresponding part of the live event.

27. A memory as in claim 26, wherein broadcasting at least part of the stored data uses time compression such that the stored data is broadcast at a faster rate than the live event.

28. A memory as in claim 26, wherein broadcasting at least part of the stored data uses editing such that less than all of the stored data is broadcast.

29. A memory as in claim 24, wherein the step of storing data for the live event further comprises storing data for the live event before the interruption.

30. A memory as in claim 24, wherein the instructions further comprise the step of providing an operator with an indication of an amount of stored data, an amount of additional data that can be stored, or both an amount of stored data and an amount of additional data that can be stored.

31. A memory as in claim 23, wherein the live event is a football game, the interruption is a commercial break, and the instructions permit broadcasting of the football game to seamlessly include play that occurred during and after the interruption, thereby permitting commercials to be inserted into broadcasting the football game without use of television timeouts or instant replays.

32. A method of broadcasting an event including steps of inserting one or more interruptions into the broadcast of the live event such that the live event continues to occur during at least some of the interruptions in the broadcast, wherein parts of the live event that occur during those interruptions are broadcast seamlessly with parts of the live event that occur after those interruptions.

33. A memory storing information including instructions executable by a processor to control broadcasting an event, the instructions including steps of inserting one or more interruptions into the broadcast of the live event such that the live event continues to occur during at least some of the interruptions in the broadcast, wherein parts of the live event that occur during those interruptions are broadcast seamlessly with parts of the live event that occur after those interruptions.
